(19) United States
(12) Patent Application Publication
(10) Pub. No.: US 2026/0197712 A1
(43) Pub. Date: Jul. 9, 2026

(54) CARRIER AGGREGATION IN MULTIPLE DIFFERENT SERVICE PROVIDER NETWORKS

(71) Applicant: Charter Communications Operating, LLC, St. Louis, MO (US)

(72) Inventor: Vinayak K. Thotton Veetil, Parker, CO (US)

(21) Appl. No.: 19/015,023

(22) Filed: Jan. 9, 2025

(51) Int. Cl. H04W 28/08; H04W 24/08; H04W 24/10

(52) U.S. Cl. CPC H04W 28/0983; H04W 24/08; H04W 24/10

(57) ABSTRACT

A mobile communication device establishes first wireless communication link with a first wireless network operated by a first network service provider. The mobile communication device receives notification of a second wireless network supporting wireless bandwidth aggregation with the first wireless network. The second wireless network is operated by a second wireless network service provider independent of the first network service provider operating the first wireless network. Upon learning of the second network availability, the mobile communication device monitors a performance associated with the second wireless network. If the second wireless network provides wireless link performance above a threshold, the mobile communication device may be allocated, via a bandwidth aggregation controller, use of the second wireless network as a supplement to the first wireless network to access a remote network.

### BACKGROUND

Conventional wireless networks provide connectivity of mobile communication devices to the Internet via respective wireless access points or wireless base stations such as based on wireless protocols including WiFi™, LTE (Long Term Evolution), NR (New Radio), etc.

As an example, via first SIM (Subscriber Identity Module) information, assume that a mobile communication device establishes a respective wireless communication link with a first wireless base station. The first wireless base station is typically coupled to a so-called backhaul that provides connectivity between the first wireless base station and a remote network such as the Internet. Via communications over the respective wireless communication link, and corresponding backhaul, the mobile communication device is able to send data to and receive data from the Internet.

In certain instances, a mobile communication device is also configured with second SIM (Subscriber Identity Module) information, enabling the mobile communication device and corresponding user to connect to a second network.

To use the first network, the user of the mobile communication device may need to subscribe to the first network operated by a first network wireless network service provider. To use the second network, the user of the mobile indication device may need to subscribe to the second network operated by a second wireless network service provider.

It is further noted that the first network can be configured to primarily support voice communications. The second network can be configured to primarily support data communications.

### BRIEF DESCRIPTION OF EXAMPLES

Example configurations as discussed herein support, on behalf of a subscriber, aggregating radio channels belonging to multiple different service providers or different radio technologies associated with multiple wireless networks.

For example, a subscriber and corresponding mobile communication device may subscribe to use of a first wireless network of the multiple wireless networks. In one example, an aggregation control server such as the wireless bandwidth aggregation controller can be configured to identify out-of-network bandwidth such as one or more supplemental radio channels associated with a second wireless network to which a user of a mobile communication device does not subscribe.

The bandwidth aggregation controller can be configured to provide notification of first wireless channels available for use from the first wireless network to which the user of the mobile communication device belongs. Additionally, the bandwidth aggregation controller can be configured to provide notification of second wireless channels (supplemental bandwidth) available for use from one or more additional wireless networks to which the user of the mobile communication device does not subscribe.

A combination of the first wireless bandwidth and the second wireless bandwidth can be allocated for use by the mobile communication device to provide better link quality (such as a more robust connectivity or higher wireless data throughput rates) to the mobile communication device for accessing the remote network.

One example as discussed herein further includes gathering background usage and user experience data based on user feedback and automated data collection to improve the multi operator multi radio technology carrier aggregation feature to further fine tune and learn particular users'usage patterns and choices to offer better personalized service.

More specifically, a mobile communication device as discussed herein establishes a first wireless communication link with a first wireless network operated by a first network service provider. The mobile communication device further receives notification of a second wireless network supporting wireless bandwidth aggregation with the first wireless network. The second wireless network is operated by a second network service provider independent of the first network service provider operating the first wireless network. To use the second wireless network, the mobile communication device and corresponding user register the mobile communication device with a bandwidth aggregation controller to use the second wireless network. The bandwidth aggregation controller manages sharing of wireless bandwidth by subscribers of the first wireless network and the second wireless network, and potentially any number of wireless networks in a network environment.

In a further example, the first wireless network can be configured to notify the bandwidth aggregation controller regarding first bandwidth associated with the first wireless network, where the first wireless bandwidth may also the available for use by subscribers in the second wireless network because the first wireless bandwidth is not fully used by the first wireless network. The second wireless network can be configured to notify the bandwidth aggregation controller of second wireless bandwidth associated with the second wireless network, where the second wireless bandwidth is made available for use by the first wireless network and corresponding subscribers because the second wireless bandwidth is not fully used by the second wireless network.

Yet further, the bandwidth aggregation controller can be configured to allocate use of the first wireless bandwidth and the second wireless bandwidth on is as needed basis.

More specifically, in one example, the bandwidth aggregation controller can be configured to allocate first wireless bandwidth associated with the first wireless network for use by the mobile communication device; the mobile communication device may need more bandwidth than the first wireless bandwidth. The bandwidth aggregation controller can be configured to allocate additional bandwidth such as second wireless bandwidth associated with the second wireless network for use by the mobile education device.

Accordingly, the mobile communication device can be configured to: i) receive allocation of first wireless bandwidth for use by the mobile communication device, the first wireless bandwidth supporting communications with the first wireless network; ii) receive allocation of second wireless bandwidth for use by the mobile communication device, the second wireless bandwidth supporting communications with the second wireless network.

The mobile communication device and corresponding user may subscribe only to the first wireless network and not the second wireless network. The bandwidth sharing as supported by the bandwidth aggregation controller enables the mobile communication device and corresponding user (such as subscriber of only the first wireless network) to use a combination of the first wireless bandwidth and the second wireless bandwidth to communicate with a remote network.

As further discussed herein, the mobile communication device can be configured to receive a first alias identity value from the bandwidth aggregation controller. The bandwidth aggregation controller can be configured to assign the first alias identity value for use of the second wireless network by the mobile communication device. Assignment of the first alias identity value to use the second wireless network provides anonymity of the mobile communication device with respect to use of the second wireless network by the mobile communication device. The second wireless network is notified of the first alias identity value and allows the mobile communication device to use wireless bandwidth associated the second wireless network in accordance with the assigned alias identity value.

Subsequent to assignment, the mobile communication device then uses the first alias identity value to transmit wireless communications from the mobile communication device to and through the second wireless network to a remote network. The mobile communication device can be configured to use another identity value to transmit wireless communications from the mobile communication device to and through the first wireless network to the remote network.

In accordance with further examples, in response to receiving notification of the second wireless network supporting the wireless bandwidth aggregation with the first wireless network, the mobile communication device can be configured to monitor a quality of receiving wireless communications from the second wireless network. The mobile communication device further can be configured to generate a performance metric indicating a quality of receiving wireless communications from one or more wireless base stations in the second wireless network. The mobile communication device further can be configured to communicate the performance metric to the first wireless network, where the performance metric is used as a basis to determine whether or not to allocate use of bandwidth associated with the second wireless network to the mobile communication device for simultaneous use with the first allocated bandwidth associated with the first wireless network.

In a further example, the bandwidth aggregation controller or other suitable entity can be configured to determine if the performance metric associated with possible use of the second wireless network and corresponding available bandwidth is above a respective threshold level.

In response to a condition of detecting that the performance metric indicates link quality between the mobile communication device and the second wireless network being greater than a threshold level, the bandwidth aggregation controller can be configured to allocate use of the second bandwidth associated with the second wireless network to the mobile communication device even though it is not a subscriber of the second wireless network and corresponding second service provider. In such an instance, the mobile communication device receives control commands generated by the bandwidth aggregation controller, where the control commands notify the mobile communication device to use the second wireless network in response to the condition in which the performance metric associated with the second wireless network is detected as being above a threshold level. In accordance with the received control commands, the mobile communication device communicates with a remote network over the second wireless network via the allocated second wireless bandwidth. Additionally, the mobile communication device communicates with the remote network over the first wireless network via the allocated first wireless bandwidth.

It is further noted that the wireless bandwidth aggregation controller may determine that the second wireless bandwidth allocated to mobile communication device is needed again by the second wireless network and its corresponding subscribers. In such an instance, the wireless bandwidth aggregation controller can be configured to deallocate use of the second wireless bandwidth by the mobile communication device. This may include the bandwidth aggregation controller transmitting a termination message to the mobile communication device, notifying the mobile communication device to terminate use of the second wireless bandwidth. In response to receiving a termination message generated by the bandwidth aggregation controller to terminate use of the second wireless network, the mobile communication device discontinues use of the second wireless network to communicate with a remote network.

It is further noted that a first communication management resource associated with the first wireless network or other suitable entity can be configured to control scheduling of communications over a combination of the first wireless bandwidth associated with the first wireless network and the second wireless bandwidth associated with second wireless network.

In one example, the first wireless network generates schedule information indicating how the mobile communication device is to use the allocated first wireless bandwidth from the first wireless network and how the mobile communication device is to use the allocated second bandwidth from the second wireless network. In such an instance, the mobile communication device receives schedule information over the first wireless network, where the schedule information indicates scheduled use of the mobile communication device to use the second wireless network. Using the allocated first wireless bandwidth and the allocated second wireless bandwidth, the mobile communication device (potentially simultaneously or concurrently) transmits communications from the mobile communication device over the first wireless network and the second wireless network in accordance with the schedule information.

Yet further, it is noted that the mobile communication device can be configured to execute multiple applications including a first application and a second application. The first wireless network or other suitable entity can be configured to determine which of the first wireless network or the second wireless network is best suited to support each of the different applications. More specifically, in one example, assume that the first wireless network is deemed to best support conveyance of communications associated with the first application executed on the mobile communication device. Assume further that the second wireless network is deemed to best support conveyance of communications associated with the second application executed on the mobile communication device. In such an instance, the first wireless network or other suitable management entity can be configured to notify the mobile communication device to use the first wireless network and corresponding first wireless bandwidth to support the first executed application and to use the second wireless network and corresponding second wireless bandwidth to support the second executed application. In such an instance, the mobile communication device executes the first application and uses first wireless network and corresponding first wireless bandwidth as a way to convey first data packets between the first application executed on the mobile communication device and the remote network; the mobile communication device executes the second application and uses second wireless network and corresponding second wireless bandwidth as a way to convey second data packets between the second application executed on the mobile communication device and the remote network.

In another example, a communication management resource as discussed herein detects a mobile communication device in communication with a first wireless network over a first wireless communication link. The first wireless network is operated by a first network service provider. The communication management resource provides notification to the mobile communication device, where the notification indicates a second wireless network supporting wireless bandwidth aggregation with the first wireless network. The second wireless network is operated by a second network service provider. The communication management resource such as a bandwidth aggregation controller or other suitable entity registers the mobile communication device with a bandwidth aggregation controller to simultaneously use the first wireless network and the second wireless network.

In one example, the communication management resource allocates first wireless bandwidth for use by the mobile communication device, where the first wireless bandwidth supports wireless communications with the first wireless network; the communication management resource allocates second wireless bandwidth for use by the mobile communication device, the second wireless bandwidth supporting communications with the second wireless network. Subsequent to the allocation, the mobile communication device uses a combination of the first wireless bandwidth and the second wireless bandwidth to communicate with a remote network.

In accordance with further examples, the mobile communication device uses a first unique identifier value assigned to support conveyance of wireless communications with the first wireless network. The communication management resource as discussed herein can be configured to assign a second unique identifier value such as a first alias identity value to the mobile communication device for use of the second wireless network.

In a further example, the communication management resource communicates the first alias identity value to the mobile communication device over a combination of the first wireless network and the first wireless communication. Thus, when communicating with the first network, the mobile communication device uses the first unique identifier value to identify itself with the first network. When communicating with the second wireless network, the mobile communication device uses the second unique identifier value such as the first alias identity value assigned to the mobile communication device to uniquely identify itself with respect to the second network.

Use of the alias identifier value protects the privacy of the mobile communication device and corresponding user.

In yet further examples as discussed herein, the mobile communication device can be configured to transmit a notification indicating availability of the second wireless network. The mobile communication device can be configured to further perform operations of: in response to receiving notification of the second wireless network supporting the wireless bandwidth aggregation with the first wireless network, monitor a quality of receiving wireless communications from the second wireless network; generate a performance metric indicating a quality of receiving the wireless communications from the second wireless network; and communicate the performance metric over the first wireless communication link to the first wireless network.

Still further, the communication management resource as discussed herein can be configured to: generate control commands notifying the mobile communication device to use the second wireless network in response to the communication management resource or other suitable entity detecting a condition in which the performance metric is above a threshold level; and transmit the control commands to the mobile communication device.

Note further that the communication management resource as discussed herein can be configured to terminate use of the first wireless network by the mobile communication device. In one example, the communication management resource generates a termination message to deallocate the second bandwidth from use by the mobile communication device to use the second wireless network. In such an instance, the communication management resource communicates the termination message over the first network and the first wireless communication link to the mobile communication device, where the termination message operative to terminate use of the second wireless network by the mobile communication device. Alternatively, the second wireless network can be configured to transmit the terminations message to the mobile communication device.

In accordance with further examples, the communication management resource as discussed herein can be configured to manage conveyance of first communications between the mobile communication device and the first wireless network; the communication management resource can be configured to manage conveyance of second communications between the mobile communication device in the second wireless network. In one example, the communication management resource produces schedule information indicating scheduled use of the mobile communication device to use the second wireless network; the communication management resource then communicates the schedule information over the first wireless network and a first wireless communication link to the mobile communication device. The mobile communication device controls conveyance of the first communications and the second communications based upon the schedule information.

As previously discussed, the mobile communication device can be configured to execute multiple applications including a first application and a second application. The first wireless network or other suitable entity (such as the communication management resource) can be configured to determine which of the first wireless network or the second wireless network is best suited to support conveyance of communications associated with each of the different applications.

These and other examples as discussed herein are beneficial to provide better use of available wireless resources. For example, the first wireless network and the second wireless network can be configured to share use of available resources to provide their respective subscribers better wireless access. More specifically, the sharing of wireless bandwidth by a first wireless network and a second wireless network enables subscribers of the first wireless network to use supplemental bandwidth associated with the second wireless network when the supplemental bandwidth associated with the second wireless network is not used by the subscribers of the second wireless network. Conversely, subscribers of the second wireless network are able to use supplemental bandwidth associated with the first wireless network when the supplemental bandwidth associated with the first wireless network is not used by subscribers of the first wireless network. This sharing provides a better overall use of available wireless resources.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a computer readable storage hardware or medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources in a network environment. The instructions, when executed by computer processor hardware, cause the computer processor hardware (such as one or more co-located or disparately processor devices or hardware) to: establish a first wireless communication link with a first wireless network operated by a first network service provider; receive notification of a second wireless network supporting wireless bandwidth aggregation with the first wireless network, the second wireless network operated by a second network service provider; and register the mobile communication device with a bandwidth aggregation controller to use the second wireless network.

Another example as discussed herein includes a computer readable storage medium and/or system having instructions stored thereon to facilitate better use of available wireless resources in a network environment. The instructions, when executed by computer processor hardware, cause the computer processor hardware (such as one or more co-located or disparately processor devices or hardware) to: detect a mobile communication device in communication with a first wireless network over a first wireless communication link, the first wireless network operated by a first network service provider; provide notification to the mobile communication device, the notification indicating a second wireless network supporting wireless bandwidth aggregation with the first wireless network, the second wireless network operated by a second network service provider; and register the mobile communication device with a bandwidth aggregation controller to simultaneously use the first wireless network and the second wireless network.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of network access. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment supporting conveyance of communications between multiple mobile communication devices and corresponding one or more target devices in a network environment the shared use of multiple wireless networks as discussed herein.

FIG. 2 is an example diagram illustrating management information and shared wireless bandwidth amongst multiple wireless network service providers as discussed herein.

FIG. 3 is an example flow chart illustrating operations associated with a mobile communication device establishing a respective wireless communication link with a primary network as discussed herein.

FIG. 4 is an example diagram illustrating a network environment implementing operations associated with a wireless bandwidth aggregation controller and allocation of wireless bandwidth from one or more wireless network service providers as discussed herein.

FIG. 5 is an example flow chart diagram illustrating aggregation management as discussed herein.

FIG. 6 is an example diagram illustrating a network environment implementing operations associated with fallback use of wireless resources associated with a respective mobile communication device in response to termination of bandwidth usage as discussed herein.

FIG. 7 is an example flow chart illustrating aggregation management as discussed herein.

FIG. 8 is an example diagram illustrating a network environment implementing wireless service termination as initiated by a respective instance of user equipment as discussed herein.

FIG. 9 is an example flow chart illustrating termination of using wireless services associated with a second network as discussed herein.

FIG. 10 is an example diagram illustrating a network environment implementing wireless service termination as initiated by a respective network as discussed herein.

FIG. 11 is an example flow chart illustrating termination of using wireless services associated with a second wireless network as discussed herein.

FIG. 12 is an example diagram illustrating operations of terminating use of a wireless communication link to a second network as discussed herein.

FIG. 13 is an example flow chart illustrating termination of using wireless services and a second wireless network as discussed herein.

FIG. 14 is an example diagram illustrating example computer architecture operable to execute one or more operations as discussed herein.

FIG. 15 is an example diagram illustrating a method as discussed herein.

FIG. 16 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A mobile communication device establishes a first wireless communication link with a first wireless network operated by a first network service provider. The mobile communication device receives notification of a second wireless network supporting wireless bandwidth aggregation with the first wireless network. The second wireless network is operated by a second wireless network service provider independent of the first network service provider operating the first wireless network. Upon learning of the second network availability, the mobile communication device monitors a performance associated with the second wireless network. If the second wireless network provides wireless link performance above a threshold, the mobile communication device may be allocated, via a bandwidth aggregation controller, use of the second wireless network and corresponding bandwidth as a supplement to the first wireless network and corresponding first bandwidth to access a remote network.

Thus, in one example, so-called carrier aggregation is implemented in accordance with any suitable wireless communication protocol via assigning radio channels belonging to different service providers to improve the overall communication throughput performance to the user. In other words, the carrier aggregation amongst multiple different wireless network service providers as discussed herein (which may implement the same or different radio technologies) enables better link performance between the user equipment and a remote network.

In a further example, a user operating the mobile communication device may subscribe to a primary operator (first wireless network service provider), where user equipment implements signaling and control plane information supported by a primary wireless network implemented by the primary operator. The UE (a.k.a., user equipment) can be configured to transmit any and all the wireless signal measurements that it performs and other relevant information to its primary operator over the primary wireless network operated by the primary service provider. The aggregated radio channels allocated for use by the user equipment may belong to different network operators (different wireless network service providers) that are broadcasting in the same area where the user equipment resides. The borrowed radio bandwidth from secondary or tertiary wireless network service providers may be implemented by those service providers using the same or different radio technology than the primary wireless network service provider.

Yet further, the communication system as discussed herein can be configured to include a so-called bandwidth aggregation controller (a.k.a., aggregation server). The wireless bandwidth aggregation controller coordinates amongst the different participating wireless network service providers to learn of available bandwidth resources (such as channels, sub channels, carrier frequencies, subcarrier frequencies, etc.) for sharing amongst each other to support wireless connectivity associated with their different subscribers. As its name suggest, the bandwidth aggregation controller can be configured to allocate use of the different available bandwidth resources to the subscribers of different wireless network service providers.

The aggregation server may be owned or operated by one of the wireless network service providers or by a third-party service provider independent of the participant wireless network service providers.

Further examples as discussed herein include assigning the different instances of user equipment alias identity values (outside its realm of primary subscription to the first wireless network service provider) and circumstances in which the user equipment is assigned in uses supplemental bandwidth from a secondary wireless network service provider. In one example, the aggregation server can be configured to utilize a hashed first UE identity value to produce a second identity value for use across one or more of the different network operators and corresponding networks. The aggregation server can be configured to continuously rotate a respective hashed primary identifier of the user equipment for use of the bandwidth in different wireless networks to ensure UE security.

It is further noted that the user equipment can be configured to provide wireless bandwidth usage information and corresponding user experience data usage back to the aggregation server. This helps to help fine tune the process and optimize the aggregation and reassignment of different wireless bandwidth for use by the different instances of user equipment in the network environment.

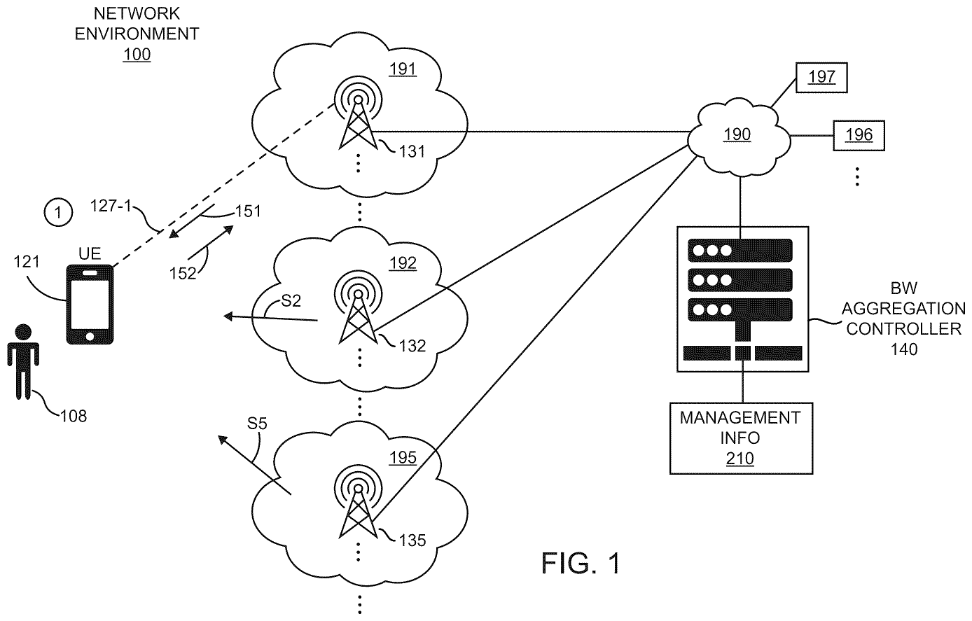

Now, more specifically, with reference to the drawings, FIG. 1 is an example diagram illustrating a wireless network environment supporting conveyance of communications between multiple mobile communication devices and corresponding one or more target devices in a network environment as discussed herein.

In one example, the network environment 100 includes multiple wireless networks including wireless network 191 controlled and operated by a first wireless network service provider, wireless network 192 controlled and operated by a second wireless network service provider, third wireless network 193 control and operated by a third wireless network service provider, and so on.

In this example, each of the wireless networks 191, 192, 193, etc., provide overlapping wireless coverage such that the user equipment 121 is able to communicate with each of the one or more wireless networks 191, 192, 193, etc., while at any location in the network environment 100.

It is further noted that each of the wireless networks can be configured to include multiple wireless base stations or multiple wireless access points supporting wireless connectivity with one or more mobile communication devices such as including user equipment 121.

As further shown, the network environment 100 includes remote network 190 and corresponding one or more server resources (communication hardware) such as including server resource 195, server resource 196, etc.

Further, the network environment 100 includes the bandwidth aggregation controller 140. As its name suggests, the bandwidth aggregation controller is configured to manage allocation of bandwidth from one or more different wireless networks to one or more instances of user equipment (mobile communication devices) present in the network environment 100.

Note further that each of the entities in the network environment 100 as discussed herein can be configured as hardware, software, or a combination of hardware and software. More specifically, the bandwidth aggregation controller 140 can be configured as bandwidth aggregation controller hardware, bandwidth aggregation controller software, or a combination of bandwidth aggregation controller hardware and bandwidth aggregation controller software; the wireless network 191 can be configured as wireless network hardware, wireless network software, or a combination of wireless network hardware and wireless network software; wireless network 192 can be configured as wireless network hardware, wireless network software, or a combination of wireless network hardware and wireless network software; wireless network 193 can be configured as wireless network hardware, wireless network software, or a combination of wireless network hardware and wireless network software; mobile communication device 121 can be configured as user equipment hardware, user equipment software, or a combination of user equipment hardware and user equipment software; and so on.

Further in this example, a mobile communication device 121 (user equipment) establishes a first wireless communication link 127-1 with a first wireless network 191 operated by a first network service provider. Via communications 151 received from the wireless network 191, the mobile communication device 121 further receives notification of one or more wireless networks such as wireless network 192, wireless network 193, etc., supporting wireless bandwidth aggregation with the first wireless network 191. As previously discussed, the second wireless network 192 is operated by a second network service provider; the third wireless network may be operated by a third wireless network service provider, and so on.

Each of the wireless networks is assigned corresponding bandwidth to support respective wireless communications with corresponding subscriber user equipment (mobile communication devices). Aggregation as discussed herein includes implementing the bandwidth aggregation controller 140 to communicate with each of the wireless networks to learn of bandwidth assigned to each of those networks. The wireless networks notify the bandwidth aggregation controller 140 of respective bandwidth they are willing to share with the other wireless networks.

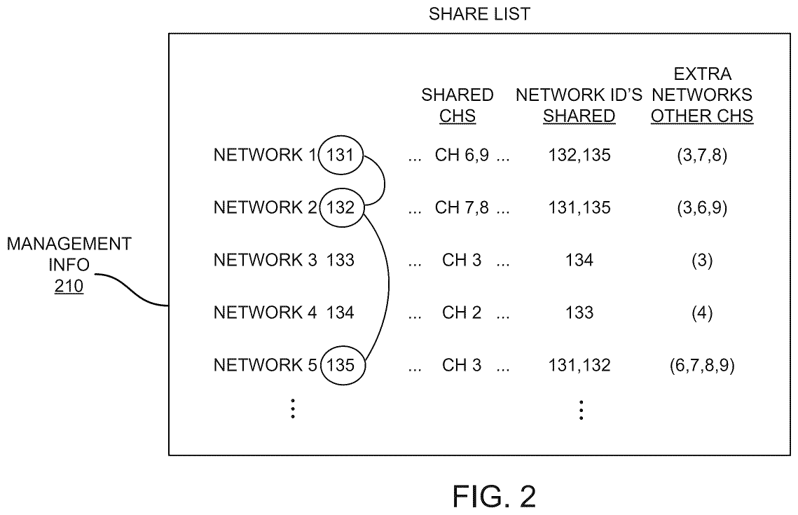

For example, as shown in FIG. 2, via corresponding management information 210, the first wireless network 191 is assigned use of bandwidth such as wireless channels 6 and 9 to support communications with respective subscriber mobile communication devices; the wireless network 192 is assigned use of bandwidth such as wireless channels 7 and 8 to support wireless communications with respective subscriber mobile communication devices; the wireless network 193 is assigned use of bandwidth such as wireless channel 3 to support wireless communications with respective subscriber mobile communication devices; . . . ; the wireless network 195 is assigned use of wireless channel 3 to support wireless communications with respective subscriber mobile communication devices; and so on.

As further shown in the management information 210, the wireless network service provider operating the wireless network 191 has an agreement to share wireless bandwidth with the wireless network service provider associated with wireless network 192 and the wireless network service provider associated with the wireless network 195; the wireless network service provider operating the wireless network 192 has an agreement to share wireless bandwidth with the wireless network service provider associated with wireless network 191 and the wireless network service provider associated with the wireless network 195; the wireless network service provider operating the wireless network 193 has an agreement to share wireless bandwidth with the wireless network service provider associated with wireless network 194; the wireless network service provider operating the wireless network 194 has an agreement to share wireless bandwidth with the wireless network service provider associated with wireless network 193; the wireless network service provider operating the wireless network 195 has an agreement to share wireless bandwidth with the wireless network service provider associated with wireless network 191 and the wireless network service provider associated with the wireless network 192; and so on.

Note that the management information 210 may be or include a so-called share list in which the different wireless networks are able to borrow use of bandwidth from other wireless networks.

In certain instances, each of the wireless networks may not share all of their channels. For example, the wireless network 191 may also be assigned use of the wireless channel 5. However, the wireless network 191 may choose not to share wireless channel 5 with any of the other wireless networks. The wireless network 192 may be assigned use of the wireless channel 1. However, the wireless network 192 may choose not to share wireless channel 1 with any of the other wireless networks, and so on

In such an instance, because the wireless network 191 has an agreement with the operator of wireless network 192 and the wireless network 195, the user equipment and corresponding user that subscribes to use of the first wireless network 191 may be able to use the supplemental channels 3, 7, and 8 if they are available via bandwidth aggregation control supported by the bandwidth aggregation controller 140; because the wireless network 192 has an agreement with the operator of wireless network 191 and the wireless network 195, the user equipment and corresponding user that subscribes to use of the second wireless network 192 may be able to use the supplemental channels 3, 6, and 9 via bandwidth aggregation control supported by the bandwidth aggregation controller 140; and so on.

Referring again to FIG. 1, in this example, the mobile communication device 121 establishes a first wireless communication link 127-1 with a first wireless network 191 operated by a first network service provider. The wireless communication link 127-1 provides the user 100 and corresponding mobile communication device 121 access through the wireless base station 131 and the wireless network 191 to the remote network 190.

Each of the wireless network service providers can be configured to notify the bandwidth aggregation controller 140 of the different policies of sharing respective wireless bandwidth with different networks.

In this example, the first wireless network 191 can be configured to notify the bandwidth aggregation controller 140 regarding first bandwidth (channels 6 and 9) associated with the first wireless network 191, where the first wireless bandwidth is available for use by the second wireless network 192 potentially because the first wireless bandwidth is not fully used by the first wireless network 191.

The second wireless network can be configured to notify the bandwidth aggregation controller 140 of second wireless bandwidth (such as channel 7 and 8) associated with the second wireless network 192, where the second wireless bandwidth is made available for use by the first wireless network 191 and the wireless network 195 because the second wireless bandwidth may not fully used by the second wireless network 192.

The fifth wireless network 195 can be configured to notify the bandwidth aggregation controller 140 of fifth wireless bandwidth (such as channel 3) associated with the fifth wireless network 195, where the fifth wireless bandwidth is made available for use by the first wireless network 191 and the second wireless network 192 based on the shared use agreement.

Assume that the mobile communication device 121 (connected to the first wireless network via the wireless communication link 127-1) desires to increase a data rate of communicating with the remote network 190 and one or more of the server resources 195, 196, etc. In such an instance, the mobile communication device 121 can be configured to inquire with the network 191 or the bandwidth aggregation controller 140 about availability of supplemental wireless bandwidth supported by partnership wireless networks (192, 195, etc.) with respect to the first wireless network service provider operating the wireless network 191.

In one example, the bandwidth aggregation controller 140 or other suitable entity uses the management information 210 as a basis in which to determine what other bandwidth is potentially available for use by the user equipment 121 based on a partnership between the wireless network service provider associated with the wireless network 191 and other wireless networks.

In this example, the bandwidth aggregation controller 140 determines that the operators of network 191, network 192, and network 195 support cross channel use in sharing in a manner as previously discussed. The bandwidth aggregation controller 140 determines what other wireless channels (bandwidth) may be used by the mobile communication device 121 via mapping the network 191 to the networks 192 and 195. The bandwidth aggregation controller 140 or other suitable entity further determines what channels are potentially available for use by the mobile communication device 121 via further mapping (via the management information 210) of the network 192 to the channel 7 and 8 as well as mapping the wireless network 195 to the channel 3.

The bandwidth aggregation controller 140 transmits a notification, such as via communications 151, indicating the possibility of other channels for use by the mobile communication device 121 from the other networks 192 and network 195. As further discussed below, the mobile communication device 121 can be configured to perform testing of those different networks and corresponding potentially available channels 3, 7, and 8 to determine if the supplemental channels and wireless networks are good candidates for use by the mobile communication device 121. In certain instances, the mobile communication device 121 may be out of range with respect to one of more of any of the networks in the network environment 100.

In response to the inquiry regarding available channels and bandwidth, or simply because the wireless network 191 provides notification of same without receiving an inquiry, via communications 152, the mobile communication device 121 receives notification (such as specifying channels 3, 7, and 8) of the wireless network 192 and the wireless network 195 that support wireless bandwidth aggregation with the first wireless network 191.

As previously discussed, the wireless network 192 is operated by a second wireless network service provider. The wireless network 195 is operated by a fifth wireless network service provider.

As further discussed herein, prior to using the wireless network 192 or the wireless network 195 and corresponding channels 3, 7, and 8, the mobile communication device 121 and corresponding user 108 (a.k.a., subscriber to use of the first wireless network and the first wireless network service provider), the mobile communication device 121 and corresponding user 108 register the mobile communication device 121 with the first wireless network 191 and the bandwidth aggregation controller 140 to use any of the wireless network 192 or wireless network 195.

As previously discussed, the wireless bandwidth aggregation controller 140 manages sharing of wireless bandwidth by subscribers of the first wireless network 191 and the second wireless network 192 and the fifth wireless network 195, and potentially any number of wireless networks in a network environment 100.

In further examples, to use the second wireless network 192, the mobile communication device 121 and corresponding user 108 can be configured to register the mobile communication device 121 with a bandwidth aggregation controller 140 for possible use of the second wireless network 192. Prior to using any of the bandwidth associated with the wireless network 192, or even prior to the mobile communication device 121 registering with the bandwidth aggregation controller 140, the mobile communication device 121 can be configured to measure the performance associated with each of the wireless networks 192 and 195 and corresponding wireless channels 3, 7, and 8.

To determine a performance of the wireless networks 192 and 195, the mobile communication device 121 measures a signal strength of receiving one or more signals S2 and S5 from the participating wireless networks including wireless network 192 and wireless network 195.

More specifically, the wireless base station 132 in the wireless network 192 transmits a wireless signal S2 at a known wireless power level. The mobile communication device 121 receives the wireless signal S2 and measures its corresponding signal strength as received by the mobile communication device 121. Based on the received signal strength of receiving the wireless signal S2, the mobile communication device 121 produces a metric RP2 indicating same. If desired, the mobile communication device 121 can be configured to produce respective metric RP2-7 indicating a respective wireless signal strength associated with the mobile communication device 121 receiving a wireless signal transmitted from the wireless base station 132 over the channel 7; the mobile communication device 121 can be configured to produce respective metric RP2-8 indicating a respective wireless signal strength associated with the mobile communication device 121 receiving a wireless signal transmitted from the wireless base station 132 over the channel 8.

Additionally, the wireless base station 135 and the wireless network 195 transmit a signal S5 via the wireless channel 3 at a known wireless power level. The mobile communication device 121 receives the wireless signal S5 over the wireless channel 3 and measures its corresponding signal strength. Based on the received signal strength of receiving the wireless signal S5 at the mobile communication device 121, the mobile communication device 121 produces a metric RP5 indicating same.

Via communications 151, the mobile communication device 121 transmits all of the performance metric information RP2 and RP5 over the wireless communication link 127-1 to the network 191 and corresponding communication management resource. The first wireless network 191 forwards the performance metrics over the network 190 to the bandwidth aggregation controller 140. Accordingly, via communications 152, the mobile communication device 121 notifies the wireless network 191 and corresponding bandwidth aggregation controller 140 of the respective detected signal strength associated with the mobile communication device 121 receiving the wireless signal S2 transmitted by the wireless network 192 over one or more different channels as well as the detected signal strength associated with the mobile communication device 121 receiving the wireless signal S5 transmitted by the wireless network 195.

As further discussed herein, the performance metrics RP2 and RP5 may be used as a basis to determine whether or not to allocate use of bandwidth associated with the second wireless network 192 or the fifth wireless network 195 to the mobile communication device 121 for possible simultaneous use or simultaneous allocation with first allocated bandwidth (such as channels 6 and 9) associated with the first wireless network 191 already allocated for use by the mobile communication device 121. In other words, because the user 108 subscribes to use of the first wireless network 191, the mobile communication device 121 automatically is able to use the channels 6 and 9 associated with the first wireless network 191.

In a further example, the bandwidth aggregation controller 140 or other suitable entity can be configured to determine if each of the performance metrics associated with possible use of the second wireless network and the fifth wireless network is above a link quality threshold.

In other words, assume in this example that the bandwidth aggregation controller 140 compares the signal strength RP5 (communications over the wireless channel 3) to a link quality threshold level and determines that the signal strength RP5 is less than the threshold level. In such an instance, this indicates that the quality between the mobile communication device and the wireless base station 135 is poor. Accordingly, the bandwidth aggregation controller 140 or other suitable entity determines that the wireless network 195 (and use of corresponding wireless channel 3) is not a good candidate to support additional bandwidth between the mobile communication device 121 and the wireless network 195.

Conversely, assume in this example that the bandwidth aggregation controller 140 or other suitable entity compares the signal strength RP2 (such as a single strength of the mobile communication device 121 receiving the signal S2 over the wireless channel 7 and/or the mobile communication device 121 receiving the signal S2 over the wireless channel 8) to a link quality threshold level and determines that the signal strength RP2 is greater than the link quality threshold level for one or both of the different channel 7 and channel 8. For example the performance metric RP2-7 is greater than the threshold level and the performance metric RP2-8 is greater than the threshold level.

In such an instance, this indicates that the quality between the mobile communication device and the wireless base station 135 is good such as for the wireless channel 7 and/or the wireless channel 8, whichever the case may be. Accordingly, the bandwidth aggregation controller 140 or other suitable entity determines that the wireless network 192 and each of the wireless channel 7 and wireless channel 8 is a good candidate to support additional bandwidth between the mobile communication device 121 and the wireless network 192 (such as using the wireless base station 131).

In response to detecting that the wireless network 192 supports good wireless link quality with the mobile communication device 121, as further discussed herein, the bandwidth aggregation controller 140 or other suitable the entity can be configured to allocate use of the second bandwidth (such as one or more of channels 7 and 8) associated with the second wireless network 192 to the mobile communication device even though the user 108 is not a subscriber of the second wireless network 192 and corresponding second service provider.

In such an instance, via communications 151, the mobile communication device 121 receives control commands generated by the bandwidth aggregation controller 140 or other suitable entity, where the control commands notify the mobile communication device 121 to use the second wireless network 192 (such as more specifically the wireless base station 132) in response to the condition in which the performance metrics RP2 are detected as being above a threshold level. In accordance with the received control commands, the mobile communication device 121 is able to communicate with a remote network 190 over the second wireless network 192 via the allocated second wireless bandwidth (such as one or more channels 7 and 8) if desired.

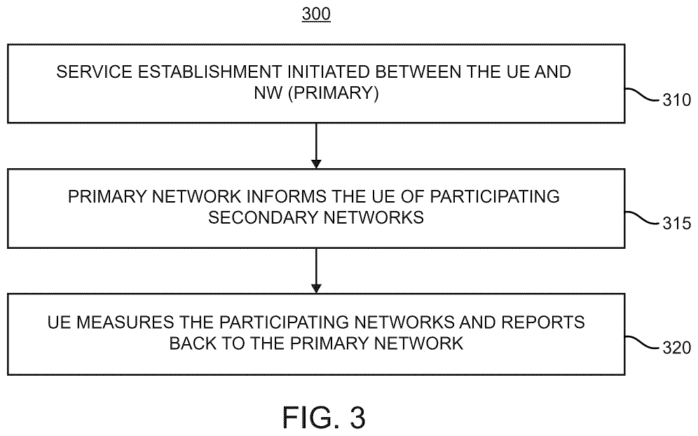

FIG. 3 is an example diagram illustrating operations associated with a wireless connection set up between a mobile communication device and a primary network as discussed herein.

For example, in processing operation 310, a combination of the mobile communication device 121 and the wireless network 191 establish a respective wireless service such as communication link 127-1.

In processing operation 315, via the communications 151, the primary network 191 can be configured to inform the mobile communication device 121 of the one or more other networks (such as network 192, network 195, etc., and corresponding wireless base stations) that potentially support wireless connectivity of the mobile communication device 121 to the remote network 190.

In processing operation 320, the mobile communication device 121 measures a single strength of receiving one or more signals S2 and S5 from the participating wireless networks including wireless network 192 and wireless network 195. Via communications 152, the mobile communication device 121 notifies the wireless network 191 and corresponding bandwidth aggregation controller 140 of the respective detected signal strength associated with the mobile communication device 121 receiving the wireless signal S2 transmitted by the wireless network 192 over one or more wireless channels 7 and 8 as well as the detected signal strength associated with the mobile communication device 121 receiving the wireless signal S5 transmitted by the wireless base station 133 in the wireless network 195.

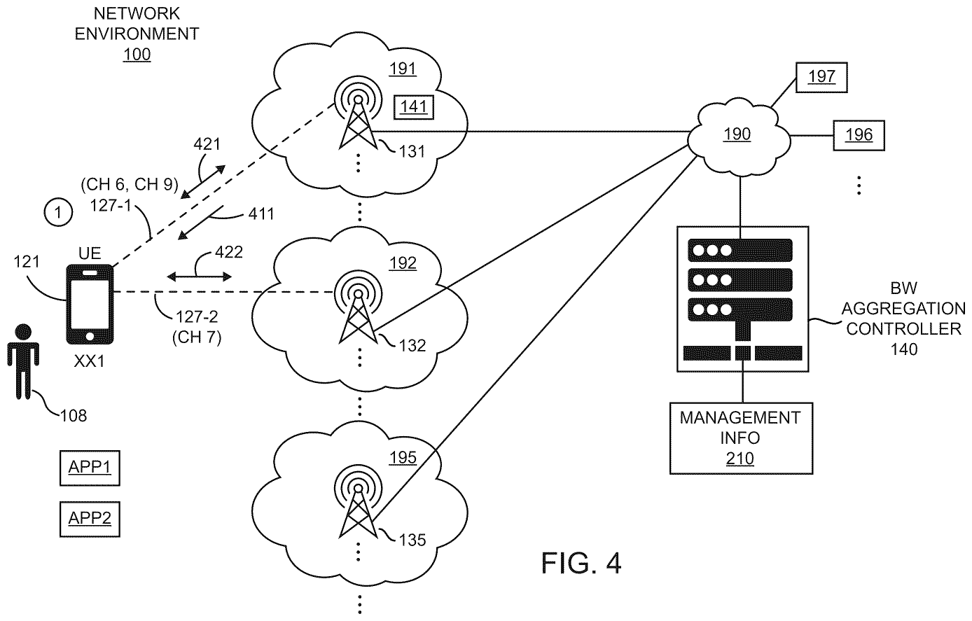

FIG. 4 is an example diagram illustrating further operations with respect to the communication system as discussed herein.

Further in this example, the communication management resource (such as any of the wireless network 191, bandwidth aggregation controller 140, etc.) as discussed herein detects the mobile communication device 121 in communication with a first wireless network 191 over a first wireless communication link 127-1. As previously discussed, the communication management resource provides notification to the mobile communication device 121 such as via communications 411, where the notification in communications 411 indicates a second wireless network 192 supporting wireless bandwidth aggregation with the first wireless network 191. The second wireless network is operated by a second network service provider.

Via communications 411 such as one or more control commands generated by the wireless network 191 or bandwidth aggregation controller 140 or other suitable entity, the bandwidth aggregation controller 140 and/or the wireless network 191 notify the mobile communication device 121 that wireless bandwidth such as wireless channel 7 associated with the wireless network 192 has been allocated for its use in addition to the mobile communication device 121 being assigned the wireless channels 6 and 9 via the first wireless network 191.

Accordingly, examples herein include generating control commands notifying the mobile communication device 121 to use the second wireless network 192 in response to a condition in which the received performance metric are detected as being above a threshold level. The wireless network 191 and corresponding wireless base station 131 transmits the control commands via communications 411 over the wireless communication link 127-1 to the mobile communication device 121.

In response to receiving the allocation of the wireless channel 7 associated with the wireless network 192 and potentially wireless channel at associated with the wireless network 192, the mobile communication device 108 establishes the respective supplemental wireless communication link 127-2 between the mobile communication device 121 and the wireless base station 132 in network 192. Via the wireless communication link 127-2 such as supporting wireless channel 7 or wireless channel at or both wireless channels 7 and 8, the mobile communication device 121 has further access to the remote network 190 and corresponding server resources.

It is further noted that the mobile communication device 121 can be configured to receive an alias identity value from the bandwidth aggregation controller or the wireless network 191 for use of the respective wireless channel 7 and wireless channel at associated with the wireless network 192. The bandwidth aggregation controller can be configured to assign the first alias identity value YY1 to the mobile communication device 121 for use of the second wireless network by the mobile communication device.

As further discussed herein, assignment of the first alias identity value YY1 to use the second wireless network 192 provides anonymity of the mobile communication device 121 with respect to the second wireless network. The second wireless network is notified of the first alias identity value YY1 and allows the mobile communication device to use wireless bandwidth associated the second wireless network in accordance with the assigned alias identity value.

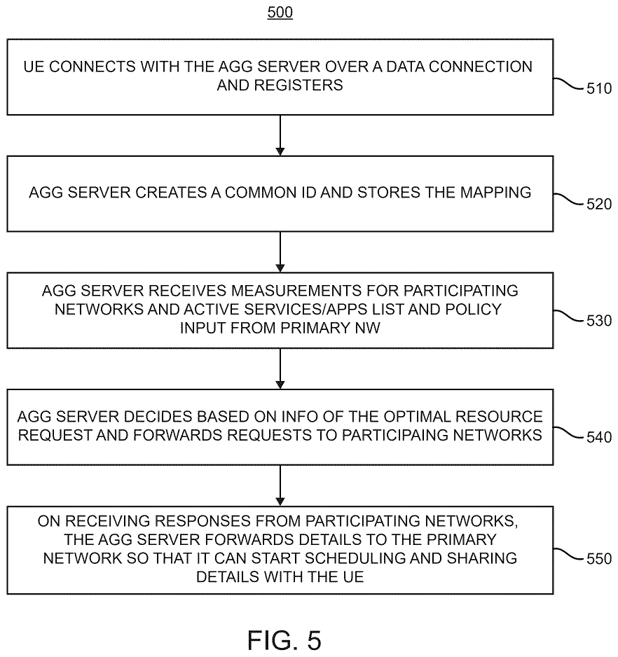

FIG. 5 is an example flow chart diagram illustrating operations associated with a bandwidth aggregation and management as discussed herein. Flowchart 500 is a summary including some of the operations as previously discussed with respect to FIG. 4.

More specifically, in processing operation 510 associated with flowchart 500 in FIG. 5, the user equipment such as the mobile communication device 121 establishes connectivity (through a wireless network 191 and network 190) with the bandwidth aggregation controller 140 and registers itself for use of additional one or more wireless channels.

In processing operation 520, the bandwidth aggregation controller 140 such as an aggregation server creates one or more so-called common identifier values associated with the mobile communication device 121 and stores the common identifier values in the management information 210 or other suitable location. In one example, the mobile communication device 121 is assigned an alias identity value YY2 (unique identifier value such as a network address or other suitable information) to use the wireless network 192 corresponding wireless base station 132. In other words, the mobile communication device 121 produces each of the data packets communicated over the wireless network 192 to include the assigned alias identity value YY2. The wireless network 192 uses the alias identity value YY2 as a basis in which to determine that the data packets were sent from the mobile communication device 121.

Note further that the management information 210 can be configured to store the assigned alias identity value YY2 for use of the wireless network 192 by the mobile communication device 121. As previously discussed, the mobile communication device can be configured with the original unique identifier value XX1 (such as a source network address of mobile communication device 121), which supports conveyance (routing) of communications between the mobile communication device 121 over the network 191 to a desired destination in the remote network 190. The mobile communication device 121 can be configured with the unique alias identifier value YY2, which supports conveyance (routing) of communications between the mobile communication device 121 over the network 192 to a desired destination (server resource 196, server resource 197, etc.).

In such an instance, the data packets transmitted from the mobile communication device 121 over the wireless network 191 to the remote network 190 may include the unique identifier value XX1, which is used to route those data packets. The data packets transmitted from the mobile communication device 121 over the wireless network 192 to the remote network 190 may include the unique identifier value YY2, which is used to route those data packets.

In processing operation 530, the bandwidth aggregation controller 140 receives the link quality performance measurements associated with the mobile communication device 121 monitoring a performance associated with each of the bandwidth sharing/participant wireless networks 192 and 195 via the signals S2 and S5 as previously discussed. The bandwidth aggregation controller 140 or other suitable entity such as the communication management resource associated with the wireless network 191 can be configured to further receive active services and an application list (APP1, APP2, etc.) associated with the mobile communication device 121 as well as policy input associated with use of any wireless channels allocated to the mobile communication device 121.

In processing operation 540, the bandwidth aggregation controller 140 or other suitable entity determines based on any information as discussed herein regarding which of the available wireless networks is best suited to provide the mobile communication device 121 supplemental access to the remote network 190. In one example, the mobile communication device 121 or other suitable entity may determine that specific services are needed to support the supplemental access to the remote network 190 such as via the application APP2. Note further that both wireless networks 192 and 195 may provide good performance to the mobile communication device 121. However, the request for supplemental bandwidth from the mobile communication device 121 may include service information indicating a particular type of wireless service that is best suited to support the supplemental access. In such an instance, even though both the wireless network 192 and the wireless network 195 may provide good link quality service, the bandwidth aggregation controller 140 may select the wireless network 192 for use by the mobile communication device 121 because it provides a particular type of wireless service as requested by the mobile communication device use the application APP2.

Thus, via communications 411, the bandwidth aggregation controller 140 can be configured to allocate use of the first wireless bandwidth (channels 6 and 9) and the second wireless bandwidth (Channel 7) on an as needed basis. More specifically, in one example, the bandwidth aggregation controller 140 or other suitable entity can be configured to allocate first wireless bandwidth (such as channel 6 and channel 9) associated with the first wireless network 191 for use by the mobile communication device 121; the bandwidth aggregation controller 140 can be configured to allocate second wireless bandwidth associated with the second wireless network 192 for use by the mobile communication device. Accordingly, the mobile communication device 121 can be configured to: i) receive allocation of first wireless bandwidth for use by the mobile communication device, the first wireless bandwidth supporting communications with the first wireless network 191; ii) receive allocation of second wireless bandwidth for use by the mobile communication device, the second wireless bandwidth supporting communications with the second wireless network 192.

In processing operation 550, in response to receiving input from each of the participating networks 192, 195, etc., as well as allocation of supplemental wireless bandwidth associated with the wireless network 192 to the mobile communication device 121, the bandwidth aggregation controller 140 forwards details regarding use of those networks to the communication management resource 141 (such as a communication scheduling manager or other suitable entity) wireless network 191. The communication management resource 141 then controls scheduling of communications 421 between the mobile communication device 121 and the network 191. The communication management resource 141 also scheduling of communications 422 between the mobile communication device 121 and the network 192.

Accordingly, subsequent to allocation of the wireless channels 6, 7, and 9, for use by the mobile communication device 121, the wireless network 191 and corresponding communication management resource 141 is in communication with the wireless network 192 and corresponding communication management resource to coordinate conveyance of communications over a combination of the wireless network 191 of the wireless network 192.

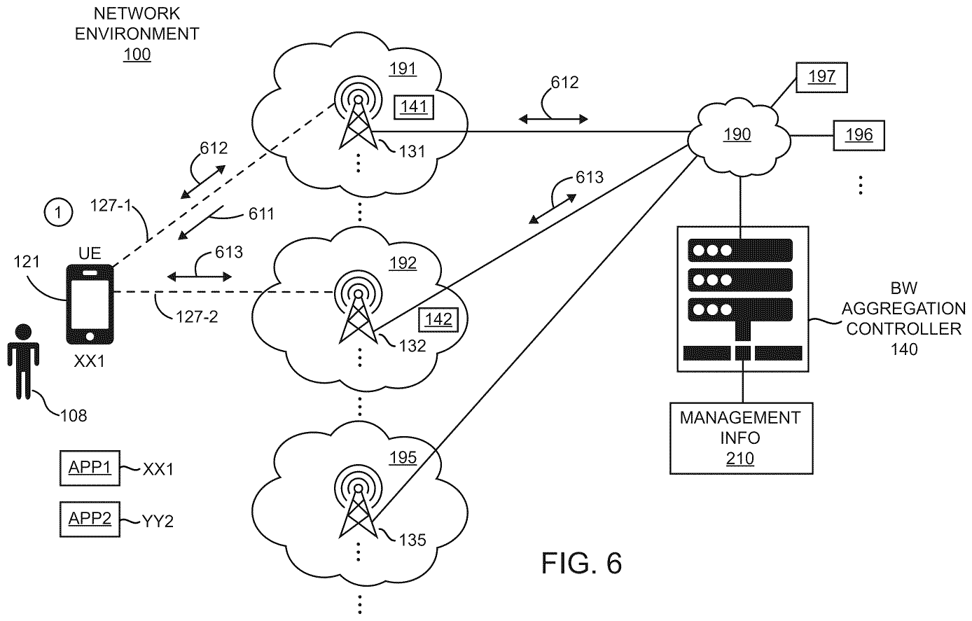

FIG. 6 is an example diagram illustrating further operations with respect to the communication system as discussed herein.

As previously discussed, the mobile communication device 121 and corresponding user 108 may subscribe only to the first wireless network 191 and not the second wireless network 192. In such an instance, the mobile communication device 121 and corresponding user 108 are guests or visitors associated with the wireless network 192 when allocated use of one or more channels 7 and/or 8. The bandwidth sharing as supported by the bandwidth aggregation controller and the corresponding participant wireless networks enables the mobile communication device 121 and corresponding user 108 (such as subscriber of only the first wireless network) to use a combination of the first wireless bandwidth (such as wireless channels 6 and 9 associated with the user 108 subscriber home network 191) associated with the first wireless network 191 and the second wireless bandwidth (such as wireless channel 7 or wireless channel 8 or both depending upon whether the channels provide good performance and the needs of the mobile communication device 121) associated with the second wireless network 192 to communicate with a remote network 190.

As further shown in FIG. 6, it is noted that the mobile communication device 121 can be configured to execute multiple applications including a first software application APP1 and a second software application APP2.

If desired, the communication management resource 140 associated with the first wireless network or other suitable entity can be configured to determine which of the first wireless network 191 or the second wireless network 192 is best suited to support each of the different applications.

More specifically, in one example, assume that the first wireless network 191 is deemed to best support conveyance of communications associated with the first application APP1 executed on the mobile communication device 121. Assume further that the second wireless network 192 is deemed to best support conveyance of communications associated with the second application APP2 executed on the mobile communication device.

In such an instance, via communications 611, the first wireless network 191 or other suitable management entity (such as communication management resource 141) can be configured to notify the mobile communication device 121 to use the first wireless network 191 and corresponding first wireless bandwidth (such as channel 6 and Channel 9) to support the first executed application APP1 and to use the second wireless network 192 and corresponding second wireless bandwidth (Channel 7 or channel at or both) to support the second executed application APP2.

In such an instance, the mobile communication device 121 executes the first application APP1 and uses first wireless network 191 and corresponding first wireless bandwidth as a way to convey first data packets (communications 612) between the first application APP1 executed on the mobile communication device and the remote network 190 and corresponding server resources; the mobile communication device 121 executes the second application APP2 and uses second wireless network 192 and corresponding second wireless bandwidth as a way to convey second data packets (communications 613) between the second application APP2 executed on the mobile communication device and the remote network.

As previously discussed, the mobile communication device 121 can be assigned a respective alias unique identity value YY2 to support conveyance of communications (a.k.a., data packets) associated with the application APP2 over the wireless communication link 127-2 corresponding wireless network 192.

Thus, the first wireless network 191 or other suitable entity can be configured to control scheduling of communications over a combination of the first wireless bandwidth (Channel 6 and 9) associated with the first wireless network 191 and the second wireless bandwidth (one or more of channels 7 and 8) associated with second wireless network 192.

In one example, the first wireless network 191 communicates with the second wireless network 192 and, via coordination between the networks, generates schedule information indicating how the mobile communication device is to use the allocated first wireless bandwidth from the first wireless network and the allocated second bandwidth from the second wireless network. In such an instance, the mobile communication device receives schedule information in communications 611 over the first wireless network 191, where the schedule information indicates scheduled use of the mobile communication device 121 to use the second wireless network 192. Using the allocated first wireless bandwidth and the allocated second wireless bandwidth, as well as the receives schedule information, the mobile communication device transmits communications from the mobile communication device over the first wireless network and the second wireless network in accordance with the schedule information.

As previously discussed, the first wireless network 191 and corresponding wireless base stations and the second wireless network 192 and corresponding wireless base stations can be configured to operate using the same time slotted configuration to support conveyance of respective wireless communications. The communication management resource 141 can be configured to communicate with the communication management resource 142 (managing timing of conveying data packets over the network 192) to receive information regarding scheduling of communications over the wireless communication link 127-2. The communication management resource 141 can be configured to communicate the schedule information over the wireless vacation link 127-1 to the mobile communication device 121. Alternatively, note that the communication management resource associated with the wireless network 192 can be configured to communicate schedule information associated with conveyance of data packets (communications 613) over the wireless communication link 127-2 to the corresponding mobile communication device 121. This alleviates the need for the wireless network 191 to manage timing associated with transmission of communications associated with the mobile communication device 121 and application APP2 over the wireless network 192.

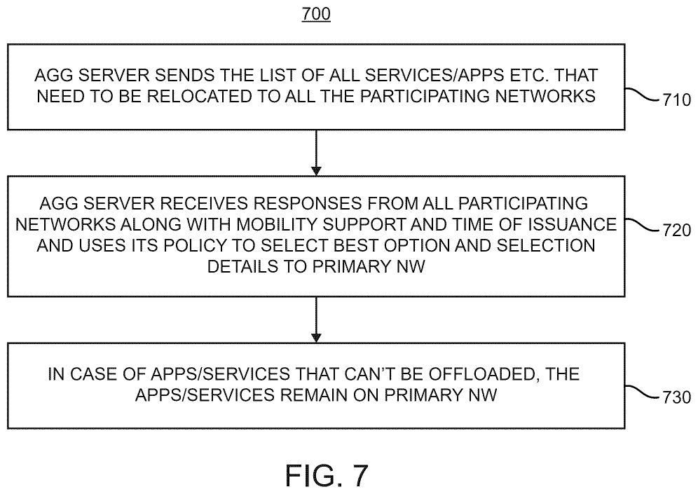

FIG. 7 is an example flow chart diagram illustrating operations associated with bandwidth aggregation and management as discussed herein. Flowchart 700 is a summary including some of the operations as previously discussed with respect to FIG. 6.

In processing operation 710 associated with the flowchart 700, the bandwidth aggregation controller 140 communicates a list of all services/applications APP1, APP2, etc., associated with the mobile communication device 121 that may be relocated to one or more participating networks.

In processing operation 720, the bandwidth aggregation controller 140 receives responses from all the participating networks 192, 195, along with mobility support and time of issuance information. The bandwidth aggregation controller 140 uses this information and policy information to select a best option of assigning the mobile communication device 121 as of a respective participating wireless network and forward such selection information to the primary wireless network 191 and corresponding communication management resource 141.

In processing operation 730, in case of applications/services (such as including application APP1) that cannot be offloaded to the participating network such as candidate wireless network 192, candidate wireless network 195, etc., those applications/services (such as application APP1) associated with the mobile communication device 121 and wireless network 191 remain serviced by the wireless network 191. However, application APP2 is a good candidate to be supported by the second wireless network 102 corresponding supplemental bandwidth.

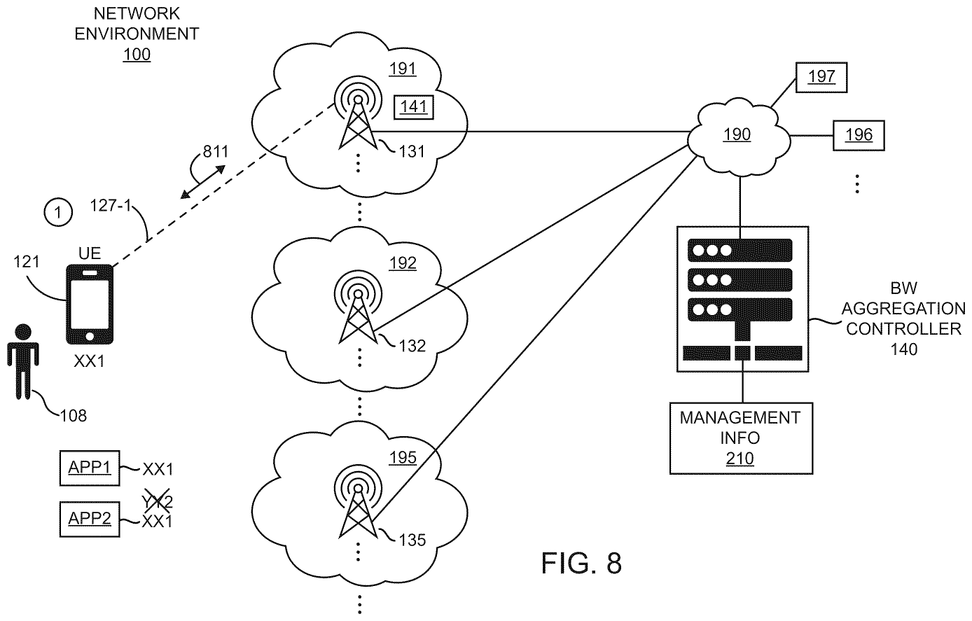

FIG. 8 is an example diagram illustrating further operations with respect to the communication system as discussed herein.

In one example, the wireless communication link 127-2 and corresponding network 192 may not be able to support conveyance of respective communications over the wireless communication link 127-2 to the remote network 190. In one example, mobile communication device 121 and/or the wireless network 192 terminates the wireless communication link 127-2. The mobile communication device 121 then switches over to conveying communications 811 associated with the first application APP1 and the second application APP2 over the wireless communication link 127-1. The user 108 of the mobile communication device 121 may also decide to terminate execution of the application APP2, in which case, the wireless network 192 corresponding wireless services are no longer needed, resulting in termination of such services.

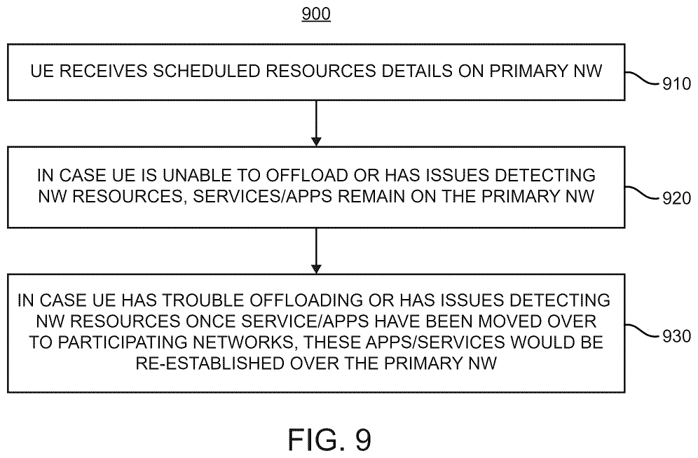

FIG. 9 is an example flow chart diagram illustrating operations associated with a bandwidth aggregation and management as discussed herein. Flowchart 900 is a summary including some of the operations as previously discussed with respect to FIG. 8 and potentially other drawings.

In processing operation 910 in the flowchart 900, the mobile communication device 121 receives scheduled resources and corresponding details from the communication management resource 141 over the wireless communication link 127-1. The schedule resources (such as timeslots in a respective wireless communication configuration supporting respect of wireless channels associated with the networks) and corresponding details may include information such as timing associated with the mobile communication device 121 scheduled for using the respective one or more supplemental wireless channels 7 or 8 associated with the wireless network 192.

In one example, the communication management resource 141 generates the schedule information associated with using the wireless network 191 and forwards it over the wireless communication link 127-1 to the mobile communication device 121. The mobile communication device 121 then uses that schedule information as a basis in which to control transmission or reception of data packets over the wireless communication link 127-2 using the alias YY2 associated with the application APP2.

In processing operation 920, in a circumstance where the mobile communication device 121 is unable to offload respective wireless services provided by the wireless communication link 127-2 and corresponding wireless network 192 to support the application APP2, or if the mobile communication device 121 has issues detecting availability of the corresponding network resources (bandwidth such as channels 7 or 8) associated with the wireless network 192 or wireless network 195, the mobile communication device 121 and corresponding services/applications fall back or revert back to using the wireless communication link 127-1 and corresponding wireless network 191 to access the corresponding remote network 190 and corresponding server resources to support communications associated with the application APP2.

In processing operation 930, in response to a circumstance where the respective mobile communication device 121 is unable to use the wireless communication link 127-2 and corresponding wireless network 192 for conveyance of communications associated with the application APP2 such as because the wireless network 192 is no longer able to provide support for wireless communication link 127-2, the application APP2 and corresponding connectivity with the remote network 190 is reestablished via use of the wireless communication link 127-1 and corresponding wireless network 191 using XX1 again. Accordingly, the mobile communication device 121 may be able to temporarily use the wireless communication link 127-2 and alias identity value YY2 to support conveyance of communications associated with the application APP2 to the remote network 190. However, the use of the corresponding wireless channels 7 and/or 8 may be revoked by the service provider associated with the wireless network 192. In such an instance, the communication management resource 141 notifies the mobile communication device 121 to discontinue use of the wireless communication link 127-2 and corresponding one or more wireless channels 7 or 8. The mobile communication device 121 and transitions back to using the wireless network 191 wireless communication link 127-1 to support conveyance of data communications with the remote network 190 and corresponding server resources for both of the applications APP1 and APP2.

Thus, in one use case, via cross-network aggregation amongst multiple different service provider networks, the mobile communication device 121 can be configured to use one or more wireless resources (bandwidth, channels, etc. ,) associated with a second network service provider and corresponding wireless network 192. Due to whatever reason, if the second network 192 is inaccessible or spotty (such as due to a respective network failure), the communication device 121 falls back to using the primary (first) network such as wireless network 191 until the one or more other wireless networks 192, 195, etc., stabilize or a time period has passed before the mobile communication device 121 attempts again to implement cross-network aggregation including wireless network services provided by other wireless networks such as wireless network 192, wireless network 195, etc.

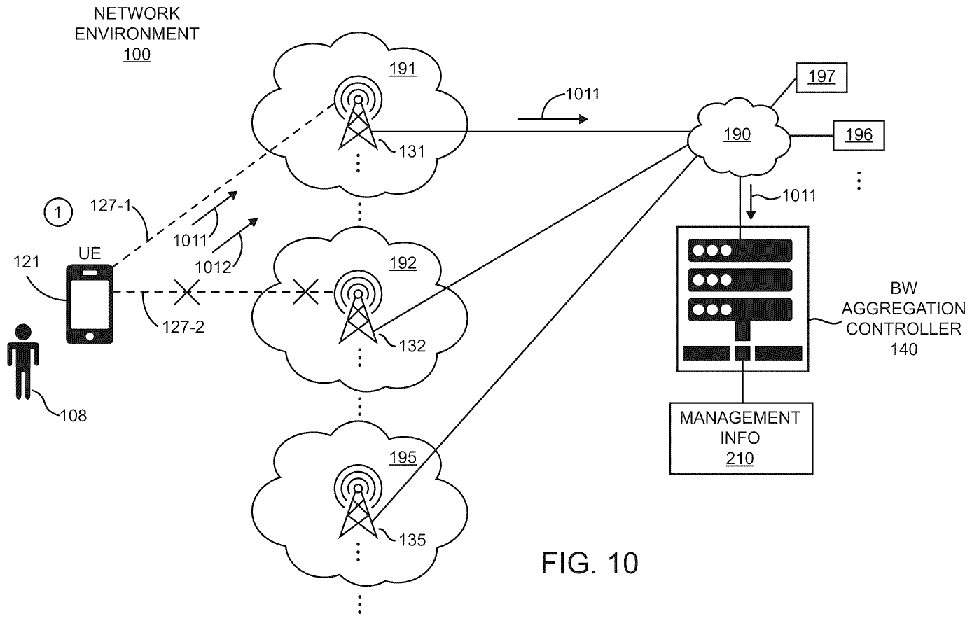

FIG. 10 is an example diagram illustrating further operations with respect to the communication system as discussed herein.

At any time, the mobile communication device 121 or other suitable entity can detect a condition in which the wireless communication link 127-2 no longer provides good service to support the application APP2 executed on the mobile communication device 121. In one example, in response to detecting this condition, the mobile communication device 121 itself can be configured to convey communications 1011 over the wireless communication link 127-1 and the wireless network 191 and network 190 to the bandwidth aggregation controller 140. The communications 1011 may include a termination request to discontinue use of the wireless communication link 127-2.

In response to detecting the low performance associated with the wireless communication link 127-2 is below a respective threshold level, the mobile communication device 121 terminates use of the wireless communication link 127-2.

Accordingly, examples herein include communication link termination initiated by the mobile communication device 121.

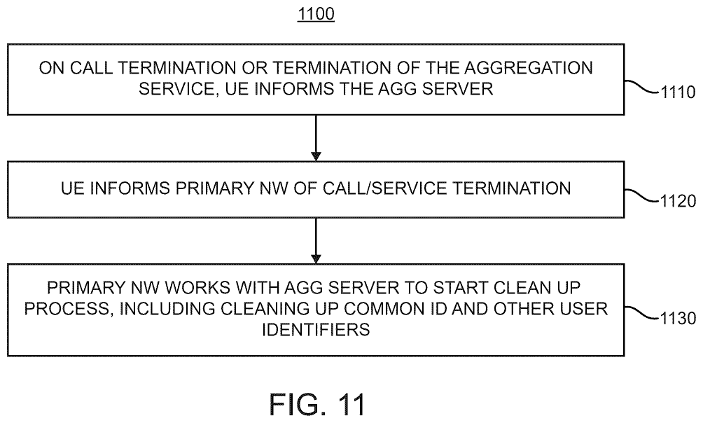

FIG. 11 is an example flow chart diagram illustrating operations associated with a bandwidth aggregation and management as discussed herein. Flowchart 1100 is a summary including some of the operations as previously discussed with respect to FIG. 10.

In processing operation 1110 associated with the flowchart 1100, the mobile communication device 121 notifies the bandwidth aggregation controller 140 to terminate use of the aggregation service including allocation of the one or more wireless channels 7 or 8 to support the wireless communication link 127-2.

Additionally, in processing operation 1120, the mobile communication device 121 notifies the wireless network 191 of the termination of the wireless communication link 127-2. If desired, the mobile communication device 121 can notify the wireless base station 132 in the wireless network 192 of the termination of the wireless communication link 127-2 of a corresponding wireless service.

In processing operation 1130, the primary wireless network 191 and corresponding communication management resource 141 communicate with the bandwidth aggregation controller 140 to cleanup and terminate use of the second wireless bandwidth as tracked by the management information 210 or other suitable entity. This may include the deleting discontinuing use of any alias identifier value such as alias unique identifier value YY2 previously used by the mobile communication device 121 to use the wireless communication link 127-2 corresponding wireless network 192.

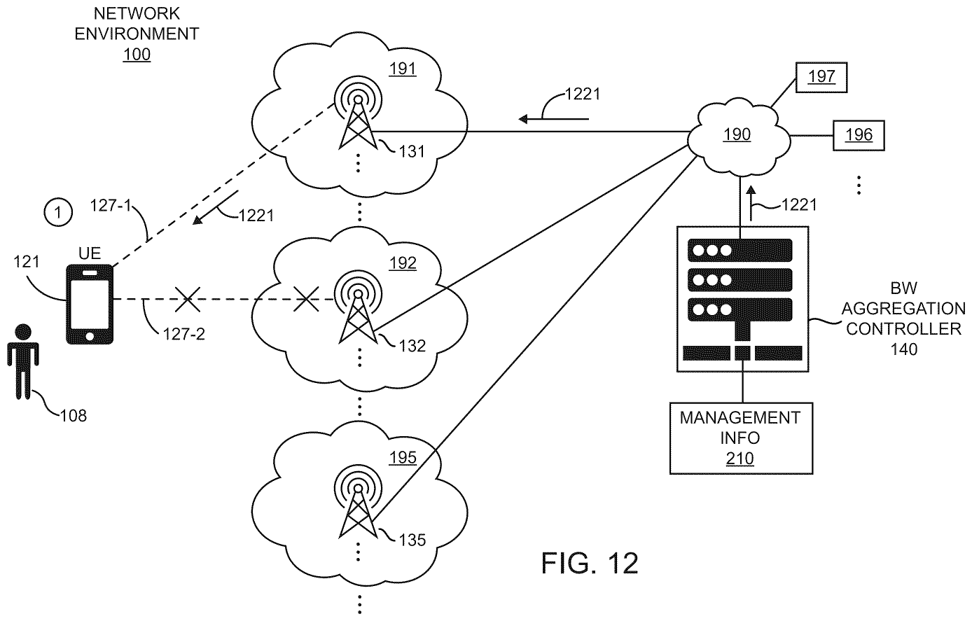

FIG. 12 is an example diagram illustrating further operations with respect to the communication system as discussed herein.

In another example, the wireless bandwidth aggregation controller 140 or other suitable entity may determine that the second wireless bandwidth temporarily allocated to mobile communication device 121 is needed again by the second wireless network 192 to support its corresponding subscribers and none of the subscribers associated with the wireless network 191. In other words, the second wireless network 192 and corresponding wireless network service provider may revoke sharing of the second wireless bandwidth such as channel 7 and channel 8. The bandwidth aggregation controller 140 or other suitable entity also may determine that the wireless communication link 127-2 does not provide sufficient link performance above a threshold level.

In either instance, or both instances, or for any other reason, the wireless bandwidth aggregation controller 140 or other suitable entity such as the communication management resource 141 can be configured to deallocate use of the second wireless bandwidth by the mobile communication device 121. This may include the bandwidth aggregation controller 140 transmitting a termination message (such as via communications 1221) to the mobile communication device 121, notifying the mobile communication device 121 to terminate use of the second wireless bandwidth (such as wireless channels 7 and 8) and corresponding wireless communication link 127-2.

In response to receiving a termination message (in communications 1221) generated by the bandwidth aggregation controller or other suitable entity to terminate use of the second wireless network 192 corresponding wireless communication link 127-2 and second bandwidth, the mobile communication device 121 discontinues use of the second wireless network and the communication link 127-2 to communicate with the remote network 190 and corresponding one or more server resources 196 and 197.

Accordingly, examples herein include the bandwidth aggregation controller 140 or other suitable entity first communicating the termination message over the first network 191 and the first wireless communication link 127-1 to the mobile communication device 121, where the termination message (communications 1221) is operative to terminate use of the second wireless network by the mobile communication device.

Accordingly, examples herein include communication link termination initiated by any of the following resources such as wireless network 192, wireless network 191, bandwidth aggregation controller 140, or other suitable entity.

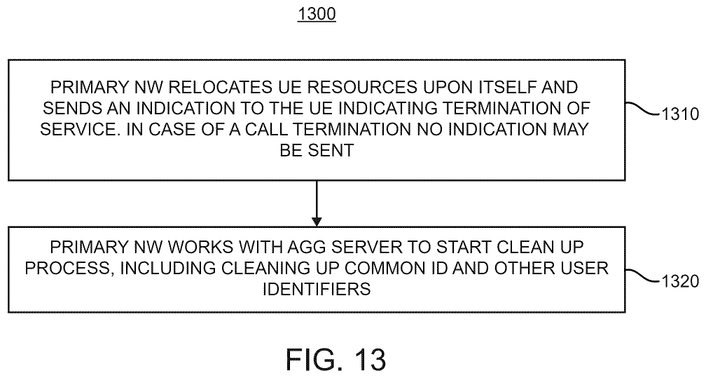

FIG. 13 is an example flow chart diagram illustrating operations associated with a bandwidth aggregation and management as discussed herein. Flowchart 1300 is a summary including some of the operations as previously discussed with respect to FIG. 12.

In this example, in processing operation 1310, the wireless network 191 reallocates wireless resource usage such as termination of wireless resources associated with the wireless communication link 127-2, second wireless bandwidth, and corresponding wireless network 192.

In processing operation 1320, the primary wireless network communicates with the bandwidth aggregation controller 140 to start cleanup of the management information supporting the allocation and use of the wireless communication link 127-2. This may include deleting any common identifier values, alias identifier values, and other user identifier value supporting the wireless communication link 127-2.

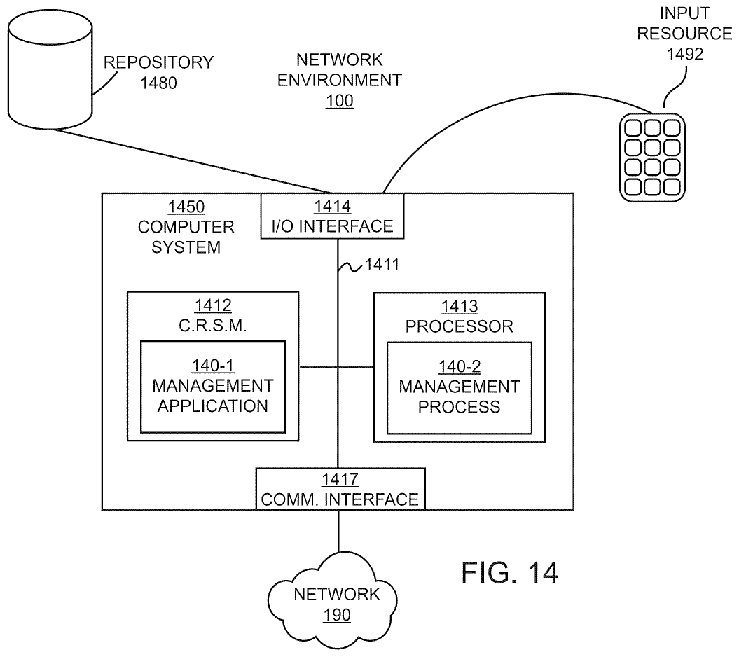

FIG. 14 is an example block diagram of a computer system for implementing any of the operations as previously discussed according to examples herein.

Any of the resources (mobile communication device 121, bandwidth aggregation controller 140, communication management resource 141, communication management resource 142, wireless network 191, wireless network 192, etc.) as discussed herein can be configured to include computer processor hardware and/or corresponding executable instructions to carry out the different operations as discussed herein via computer system 1450.

As shown, computer system 1450 of the present example includes an interconnect 1411 coupling computer readable storage media 1412 such as a non-transitory type of media or, more generally, computer readable hardware which can be any suitable type of physical hardware storage medium in which digital information can be stored and retrieved, a processor 1413 (computer processor hardware), I/O interface 1414, and a communications interface 1417.

I/O interface(s) 1414 supports connectivity to repository 1480 and input resource 1492.

Computer readable storage medium 1412 (such as computer readable hardware or other suitable entity) can be a hardware storage device or resource such as memory, optical storage, hard drive, floppy disk, etc. In one example, the computer readable storage medium 1412 stores instructions and/or data. Computer readable storage medium 1412 can be a non-transitory storage medium or include non-transitory storage hardware.

As shown, computer readable storage media 1412 can be encoded with communication management application 140-1 (e.g., including instructions) to carry out any of the operations as discussed herein.

During operation of one example, processor 1413 accesses computer readable storage media 1412 via the use of interconnect 1411 in order to launch, run, execute, interpret or otherwise perform the instructions in management application 140-1 stored on computer readable storage medium 1412. Execution of the management application 140-1 produces the management process 140-2 to carry out any of the operations and/or processes as discussed herein.

Those skilled in the art will understand that the computer system 1450 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1450 may reside at any location or can be included in any suitable resource in any network environment to implement functionality as discussed herein. In one example, the control system 1450 can include or be implemented in virtualization environments such as the cloud.

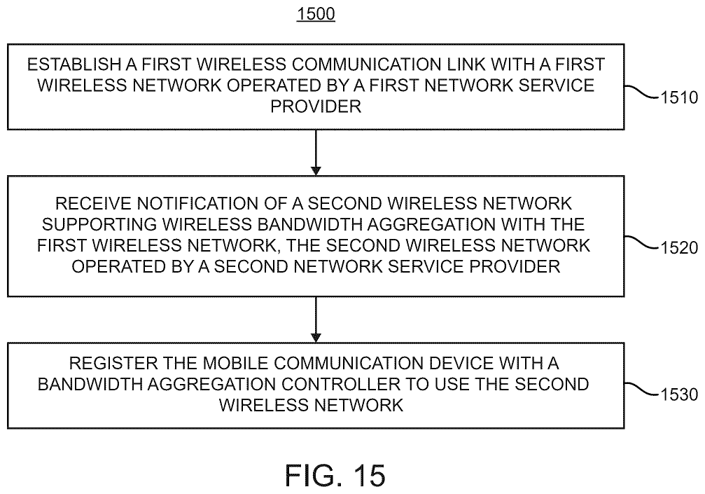

Functionality supported by the different resources will now be discussed via flowchart in FIG. 15. Note that the steps in the flowcharts below can be executed in any suitable order.

FIG. 15 is a flowchart 1500 illustrating an example method according to examples as discussed herein. Note that flowchart 1500 overlaps/captures general concepts as discussed herein.

In processing operation 1510, the mobile communication device 121 (a.k.a., user equipment) establishes a first wireless communication link 127-1 with a first wireless network operated by a first network service provider.

In processing operation 1520, the mobile communication device 121 receives notification of a second wireless network supporting wireless bandwidth aggregation with the first wireless network, the second wireless network operated by a second network service provider.

In processing operation 1530, the mobile communication device 121 or other suitable entity registers the mobile communication device 121 with a bandwidth aggregation controller to use the second wireless network.

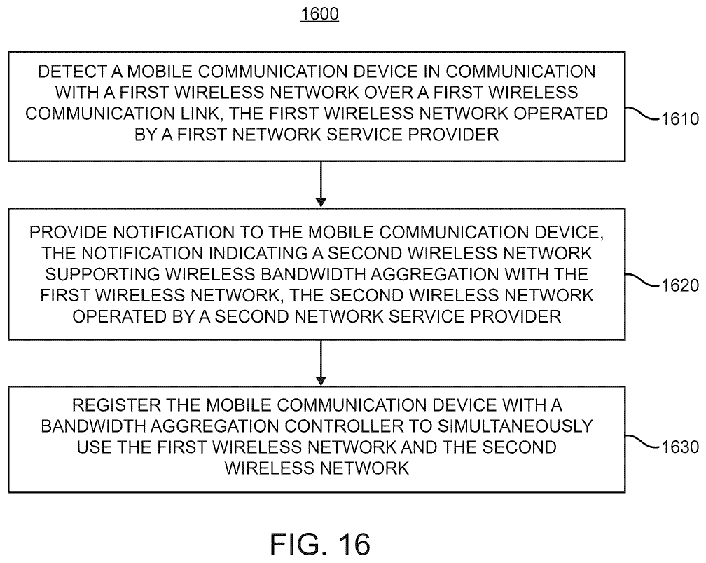

FIG. 16 is a flowchart 1600 illustrating an example method according to examples. Note that flowchart 1600 overlaps/captures general concepts as discussed herein.

In processing operation 1610, the communication management resource 140 detects a mobile communication device in communication with a first wireless network over a first wireless communication link, where the first wireless network is operated by a first network service provider.

In processing operation 1620, the communication management resource 140 provides notification to the mobile communication device, where the notification indicates a second wireless network potentially supporting or available for wireless bandwidth aggregation with the first wireless network. The second wireless network is operated by a second network service provider.

In processing operation 1630, the communication management resource 140 registers the mobile communication device with a bandwidth aggregation controller to simultaneously use the first wireless network (first wireless channels) and the second wireless network (supplemental or temporary borrowed wireless channels).

Note again that techniques herein are well suited to facilitate management of aggregating and allocating wireless bandwidth in a network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
via a mobile communication device:
establishing a first wireless communication link with a first wireless network operated by a first network service provider;
receiving notification of a second wireless network supporting wireless bandwidth aggregation with the first wireless network, the second wireless network operated by a second network service provider; and
registering the mobile communication device with a bandwidth aggregation controller to use the second wireless network.

2. The method as in claim 1 further comprising:
at the mobile communication device: i) receiving allocation of first wireless bandwidth for use by the mobile communication device, the first wireless bandwidth supporting communications with the first wireless network; ii) receiving allocation of second wireless bandwidth for use by the mobile communication device, the second wireless bandwidth supporting communications with the second wireless network.

3. The method as in claim 2 further comprising:
at the mobile communication device, using a combination of the first wireless bandwidth and the second wireless bandwidth to communicate with a remote network.

4. The method as in claim 1 further comprising:
at the mobile communication device, receiving a first alias identity value assigned to the mobile communication device, the first alias identity value assigned for use of the second wireless network.

5. The method as in claim 4 further comprising:
at the mobile communication device, using the first alias identity value to transmit wireless communications from the mobile communication device to the second wireless network.

6. The method as in claim 1 further comprising:
at the mobile communication device:
in response to receiving notification of the second wireless network supporting the wireless bandwidth aggregation with the first wireless network, monitoring a quality of receiving wireless communications from the second wireless network;
generating a link performance metric indicating a quality of receiving the wireless communications from the second wireless network; and
communicating the performance metric to the first wireless network.

7. The method as in claim 6 further comprising:
at the mobile communication device:
receiving control commands generated by the bandwidth aggregation controller, the control commands notifying the mobile communication device to use the second wireless network in response to a condition in which the link performance metric is detected as being above a threshold level; and
in accordance with the received control commands, communicating with a remote network over the second wireless network.

8. The method as in claim 1 further comprising:
at the mobile communication device, in response to receiving a termination message to terminate use of the second wireless network, discontinuing use of the second wireless network to communicate with a remote network.

9. The method as in claim 1 further comprising:
at the mobile communication device:
receiving schedule information over the first wireless network, the schedule information indicating scheduled use of the mobile communication device to use the second wireless network; and
transmitting communications from the mobile communication device over the second wireless network in accordance with the schedule information.

10. The method as in claim 1 further comprising:
at the mobile communication device:
executing a first application;
using the first wireless network to provide the first application access to a remote network;
executing a second application; and
receiving notification from the bandwidth aggregation controller to provide the second application access to the remote network over a second wireless communication link between the mobile communication device and the second wireless network.

11. A system comprising:
communication management hardware disposed in a mobile communication device, the communication management hardware operative to:
establish a first wireless communication link with a first wireless network operated by a first network service provider;
receive notification of a second wireless network supporting wireless bandwidth aggregation with the first wireless network, the second wireless network operated by a second network service provider; and
register the mobile communication device with a bandwidth aggregation controller to use the second wireless network.

12. The system as in claim 11, wherein the communication management hardware is further operative to:
i) receive allocation of first wireless bandwidth for use by the mobile communication device, the first wireless bandwidth supporting communications with the first wireless network; and ii) receive allocation of second wireless bandwidth for use by the mobile communication device, the second wireless bandwidth supporting communications with the second wireless network.

13. The system as in claim 12, wherein the communication management hardware is further operative to:
use a combination of the first wireless bandwidth and the second wireless bandwidth to communicate with a remote network.

14. The system as in claim 11, wherein the communication management hardware is further operative to:
receive a first alias identity value assigned to the mobile communication device, the first alias identity value assigned for use of the second wireless network.

15. The system as in claim 14, wherein the communication management hardware is further operative to:
use the first alias identity value to transmit wireless communications from the mobile communication device to the second wireless network.

16. The system as in claim 11, wherein the communication management hardware is further operative to:
in response to receiving notification of the second wireless network supporting the wireless bandwidth aggregation with the first wireless network, monitor a quality of receiving wireless communications from the second wireless network;
generate a performance metric indicating a quality of receiving the wireless communications from the second wireless network; and
communicate the performance metric to the first wireless network.

17. The system as in claim 16, wherein the communication management hardware is further operative to:
receive control commands generated by the bandwidth aggregation controller, the control commands notifying the mobile communication device to use the second wireless network in response to a condition in which the performance metric is detected as being above a threshold level; and
in accordance with the received control commands, indicate with a remote network over the second wireless network.

18. The system as in claim 11, wherein the communication management hardware is further operative to:
at the mobile communication device, in response to receiving a termination message generated by the bandwidth aggregation controller to terminate use of the second wireless network, discontinue use of the second wireless network to communicate with a remote network.

19. The system as in claim 11, wherein the communication management hardware is further operative to:
receive schedule information over the first wireless network, the schedule information indicating scheduled use of the mobile communication device to use the second wireless network; and
transmit communications from the mobile communication device over the second wireless network in accordance with the schedule information.

20. The system as in claim 11, wherein the communication management hardware is further operative to:
execute a first application;
use the first wireless network to provide the first application access to a remote network;
execute a second application; and
receive notification from the bandwidth aggregation controller to provide the second application access to the remote network over a second wireless communication link between the mobile communication device and the second wireless network.

21. A method comprising:
detecting a mobile communication device in communication with a first wireless network over a first wireless communication link, the first wireless network operated by a first network service provider;
providing notification to the mobile communication device, the notification indicating a second wireless network supporting wireless bandwidth aggregation with the first wireless network, the second wireless network operated by a second network service provider; and
registering the mobile communication device with a bandwidth aggregation controller to use the first wireless network and the second wireless network.

22. The method as in claim 21 further comprising:
allocating first wireless bandwidth for use by the mobile communication device, the first wireless bandwidth supporting communications with the first wireless network; and
allocating second wireless bandwidth for use by the mobile communication device, the second wireless bandwidth supporting communications with the second wireless network.

23. The method as in claim 22, wherein the mobile communication device is operative to use a combination of the first wireless bandwidth and the second wireless bandwidth to communicate with a remote network.

24. The method as in claim 21 further comprising:
assigning a first alias identity value to the mobile communication device; the first alias identity value assigned to the mobile communication device for use of the second wireless network by the mobile communication device.

25. The method as in claim 24 further comprising:
communicating the first identity value to the mobile communication device over a combination of the first wireless network and the first wireless communication link.

26. The method as in claim 21, wherein the mobile communication device is operative to:
in response to receiving notification of the second wireless network supporting the wireless bandwidth aggregation with the first wireless network, monitor a quality of receiving wireless communications from the second wireless network;
generate generating a performance metric indicating a quality of receiving the wireless communications from the second wireless network; and
communicate the performance metric over the first wireless communication link to the first wireless network.

27. The method as in claim 26 further comprising:
generating control commands notifying the mobile communication device to use the second wireless network in response to a condition in which the performance metric is detected as being above a threshold level; and
transmitting the control commands to the mobile communication device.

28. The method as in claim 1 further comprising:
communicating the termination message over the first network and the first wireless communication link to the mobile communication device, the termination message operative to terminate use of the second wireless network by the mobile communication device.

29. The method as in claim 21 further comprising:
producing schedule information indicating scheduled use of the mobile communication device to use the second wireless network; and
communicating the schedule information over the first wireless network and a first wireless communication link to the mobile communication device.

30. The method as in claim 21 further comprising:
communicating a control message to the mobile communication device, the communicated control message indicating an application on the mobile communication device to be provided connectivity with a remote network over the second wireless network.

31. Computer-readable storage hardware having instructions stored thereon, the instructions, when carried out by computer processor hardware, cause the computer processor hardware to:
establish a first wireless communication link with a first wireless network operated by a first network service provider;
receive notification of a second wireless network supporting wireless bandwidth aggregation with the first wireless network, the second wireless network operated by a second network service provider; and
register the mobile communication device with a bandwidth aggregation controller to use the second wireless network.

32. Computer-readable storage hardware having instructions stored thereon, the instructions, when carried out by computer processor hardware, cause the computer processor hardware to:
detect a mobile communication device in communication with a first wireless network over a first wireless communication link, the first wireless network operated by a first network service provider;
provide notification to the mobile communication device, the notification indicating a second wireless network supporting wireless bandwidth aggregation with the first wireless network, the second wireless network operated by a second network service provider; and
register the mobile communication device with a bandwidth aggregation controller to simultaneously use the first wireless network and the second wireless network.
